(19) United States
(12) Patent Application Publication
(10) Pub. No.: US 2008/0100538 A1
(43) Pub. Date: May 1, 2008

(54) METHOD AND APPARATUS FOR DRIVING ADDRESS ELECTRODES IN PLASMA DISPLAY PANEL

(76) Inventor: Jae-il Byeon, Seoul (KR)

Correspondence Address: F. CHAU & ASSOCIATES, LLC, 130 WOODBURY ROAD, WOODBURY, NY, 11797, US

(21) Appl. No.: 11/843,733

(22) Filed: Aug. 23, 2007

(30) Foreign Application Priority Data
Oct. 31, 2006 (KR) 10-2006-0106717

(51) Int. Cl. G09G 3/28

(52) U.S. Cl. 345/67

(57) ABSTRACT

A method for driving M address electrodes included in a plasma display panel in an address period for selecting specific discharge cells from discharge cells of N rows and M columns that applies a driving voltage rising in two stages from a reference voltage to an address voltage to the M address electrodes in a period of the address period that corresponds to a first row and applies a driving voltage tailing in two stages from the address voltage to the reference voltage to the M address electrodes in a period of the address period that corresponds to an Nth row when the discharge cells of N rows and M columns are all selected.

### CROSS-REFERENCE TO RELATED PATENT APPLICATION

This application claims the benefit of Korean Patent Application No. 10-2006-0106717, filed on Oct. 31, 2006, in the Korean Intellectual Property Office, the disclosure of which is incorporated herein in its entirety by reference.

### BACKGROUND OF THE INVENTION

1. Technical Field

The present disclosure relates to a method and apparatus for driving address electrodes in a plasma display panel and, more particularly, to a method and apparatus for driving address electrodes in a plasma display panel for reducing electromagnetic interference generated in an address period.

2. Discussion of Related Art

A plasma display panel is a type of flat panel display device that has recently received a lot of attention. The plasma display panel includes a plurality of discharge cells formed by dividing a space between two substrates on which a plurality of electrodes are formed by barriers. The discharge cells respectively correspond to pixels of the plasma display panel. When a driving voltage is applied to the discharge cells through the plurality of electrodes, the discharge cells generate vacuum UV rays by a discharging process. The vacuum UV rays excite a fluorescent substance formed in a predetermined pattern to generate visible rays. The plasma display panel displays an image corresponding to input image data using the visible rays.

FIG. 1A illustrates a conventional plasma display panel 100. Referring to FIG. 1A, the plasma display panel 100 includes discharge cells arranged in N rows and M columns. A voltage for driving the plasma display panel 100 is applied to the discharge cells through sustain electrodes X1 through XN, scan electrodes Y1 through YN and address electrodes A1 through AM. For example, the discharge cell C11 in the first row and the first column receives the driving voltage through the sustain electrode X1, the scan electrode Y1 and the address electrode A1, and the discharge cell C23 in the second row and the third column receives the driving voltage through the sustain electrode X2, the scan electrode Y2 and the address electrode A3.

FIG. 1B illustrates the driving voltage applied to the electrodes illustrated in FIG. 1A.

The plasma display panel 100 displays an image frame by frame. A unit frame is divided into a plurality of sub frames SF1, SF2, SF3, SF4, . . . to represent time division gray scales. Each sub frame SF is divided into a reset period Pr, an address period Pa, and a sustain period Ps. In the reset period Pr, reset discharge occurs between the sustain electrode Xn and the scan electrode Yn to uniformly initialize all the discharge cells. In the address period Pa, address discharge occurs between the scan electrode Yn and the address electrode Am to select specific discharge cells. In the sustain period Ps of a sub frame, sustain discharge occurs a predetermined number of times corresponding to a gray scale allocated to the sub frame SF for the discharge cells selected in the address period Pa. As illustrated in FIG. 1B, in the sustain period Ps, a sustain voltage Vs is alternately applied to the sustain electrode Xn and the scan electrode Yn.

FIGS. 2A and 2B illustrate a driving voltage applied to the scan electrode Yn and a driving voltage applied to the address electrode Am. In the address period Pa, the scan voltage Vy is sequentially applied to the first through Nth scan electrodes Y1 through YN. In the address period Pa, an address voltage Va or a reference voltage Vg corresponding to address data is applied to the address electrodes A1 through AM.

Referring to FIG. 2A, in a period 1 of the address period Pa during which the scan voltage Vy is applied to the first scan electrode Y1, the address voltage Va is applied to the first address electrode A1 and the second address electrode A2, and the reference voltage Vg is applied to the third address electrode A3 and the Mth address electrode AM. While address discharge occurs between the scan electrode Yn provided with the scan voltage Vy and the address electrode Am provided with the address voltage Va, address discharge does not occur between the scan electrode Yn provided with the scan voltage Vy and the address electrode Am provided with the reference voltage Vg. As a result, the discharge cell C11 in the first row and the first column and the discharge cell C12 (not shown) in the first row and the second column are selected while the discharge cell C13 (not shown) in the first row and the third column, and the discharge cell C1M (not shown) in the first row and the Mth column are not selected in the period 1 of the address period Pa. The discharge cell C21 (not shown) in the second row and the first column is not selected while the discharge cell C22 (not shown) in the second row and the second column, the discharge cell C23 in the second row and the third column and the discharge cell C2M (not shown) in the second row and the Mth column are selected in a period 2 of the address period Pa. The discharge cell C31 (not shown) in the third row and the first column and the discharge cell C3M (not shown) in the third row and the Mth column are selected while the discharge cell C32 (not shown) in the third row and the second column and the discharge cell C33 (not shown) in the third row and the third column are not selected in a period 3 of the address period Pa. The discharge cell CN1 (not shown) in the Nth row and the first column, the discharge cell CN3 (not shown) in the Nth row and the third column and the discharge cell CNM (not shown) in the Nth row and the Mth column are selected while the discharge cell CN2 (not shown) in the Nth row and the second column is not selected in a period N of the address period Pa.

FIG. 2B illustrates a case in which the discharge cells arranged in N rows and M columns are all selected in the address period Pa. When all the driving voltages, respectively applied to M discharge cells belonging to an arbitrary column, rise from the reference voltage Vg to the address voltage Va (in the period 1 illustrated in FIG. 2B) or fall from the address voltage Va to the reference voltage Vg (in the period N illustrated in FIG. 2B) according to M address electrodes Am, severe electromagnetic interference is generated. The electromagnetic interference caused by an abrupt current variation or voltage variation affects surrounding elements and causes the plasma display panel to abnormally operate. Accordingly; techniques for minimizing the electromagnetic interference have been proposed.

### SUMMARY OF THE INVENTION

Exemplary embodiments of the present invention provide a method and apparatus for driving address electrodes to reduce electromagnetic interference generated when discharge cells belonging to an arbitrary column are all selected or de-selected in an address period.

According to an exemplary embodiment of the present invention, there is provided a method for driving M address electrodes included in a plasma display panel in an address period for selecting specific discharge cells from discharge cells of N rows and M columns, which applies a driving voltage rising in two stages from a reference voltage to an address voltage to the M address electrodes in periods of the address period that correspond to an (n−1)th row and an nth row (n is a natural number selected from 2 through N), when M discharge cells belonging to the (n−1)th row are all de-selected and M discharge cells belonging to the nth row are all selected. The driving voltage rising in two stages is generated using an energy recovery capacitor, rises from the reference voltage to an intermediate voltage, and then rises from the intermediate voltage to the address voltage.

According to an exemplary embodiment of the present invention, there is provided a method for driving M address electrodes included in a plasma display panel in an address period for selecting specific discharge cells from discharge cells of N rows and M columns, which applies a driving voltage falling in two stages from an address voltage to a reference voltage to the M address electrodes in periods of the address period, that correspond to an (n−1)th row and an nth row (n is a natural number selected from 2 through N), when M discharge cells belonging to the (n−1)th row are all selected and M discharge cells belonging to the nth column are all de-selected. The driving voltage falling in two stages is generated using an energy recovery capacitor, falls from the address voltage to an intermediate voltage, and then fails from the intermediate voltage to the reference voltage.

A period during which the driving voltage rises from the reference voltage to the intermediate voltage may include a period during which the driving voltage is maintained at the intermediate voltage for a predetermined time. The predetermined time may he determined in consideration of the total transition time of the driving voltage rising in two stages. A period during which the driving voltage falls from the address voltage to the intermediate voltage may include a period dining which the driving voltage is maintained at the intermediate voltage for a predetermined time. The predetermined time may be determined in consideration of the total transition time of the driving voltage falling in two stages.

The capacitance of the energy recovery capacitor may be determined in consideration of the voltage level of the intermediate voltage. The voltage level of the intermediate is an average level of the voltage level of the address voltage level of the reference voltage.

According to an exemplary embodiment of the present invention, there is provided a method for driving M address electrodes included in a plasma display panel in an address period for selecting specific discharge cells from discharge cells of N rows and M columns, when all discharge cells are selected in the address period, that comprises applying a driving voltage rising in two stages from a reference voltage to an address voltage to the M address electrodes in a period of the address period that corresponds to a first row, and applying a driving voltage falling in two stages from the address voltage to the reference voltage to the M address electrodes in a period of the address period that corresponds to the Nth row. The driving voltage rising in two stages is generated using an energy recovery capacitor, rises from the reference voltage to an intermediate voltage and then rises from the intermediate voltage to the address voltage. The driving voltage falling in two stages is generated using the energy recovery capacitor, falls from the address voltage to the intermediate voltage and then falls from the intermediate voltage to the reference voltage.

The driving voltage rising in two stages rises from the reference voltage to the intermediate voltage, is maintained at the intermediate voltage for a predetermined time, rises from the intermediate voltage to the address voltage, and then is maintained at the address voltage.

The driving voltage falling in two stages falls from the address voltage to the intermediate voltage, is maintained at the intermediate voltage for a predetermined time, falls from the intermediate voltage to the reference voltage, and then is maintained at the reference voltage.

According to an exemplary embodiment of the present invention, there is provided an apparatus for driving address electrodes included in a plasma display panel in an address period for selecting specific discharge cells from discharge cells of N rows and M columns, comprising: a high-level transistor transferring an address voltage to an address electrode; a low-level transistor transferring a reference voltage to the address electrode; an energy recovery capacitor exchanging charges with a panel capacitor being an equivalent model of a discharge cell; and a bidirectional transistor connecting or disconnecting the panel capacitor to or from the energy recovery capacitor. The apparatus applies a driving voltage rising in two stages from the reference voltage to the address voltage to the address electrodes in portions of the address period that correspond to an (n−1)th row and an nth row (n is a natural number selected from 2 through N) when. M discharge cells belonging to the (n−1)th row are all de-selected and M discharge cells belonging to the nth row are all selected.

The apparatus applies a driving voltage falling in two stages from the address voltage to the reference voltage to the address electrodes in periods of the address period which correspond to an (n−1)th row and an nth row (n is a natural number selected from 2 through N) when M discharge cells belonging to the (n−1)th row are all selected and M discharge cells belonging to the nth row are all de-selected.

### BRIEF DESCRIPTION OF THE DRAWINGS

Exemplary embodiments of the present invention will be understood in more detail from the following descriptions taken in conjunction with the attached drawings, in which:

FIG. 1A illustrates a conventional plasma display panel;

FIG. 1B illustrates driving voltages applied to electrodes in the display panel illustrated in FIG. 1A;

FIGS. 2A and 2B illustrate a driving voltage applied to a scan electrode Yn and a driving voltage applied to an address electrode Am;

FIG. 3 is a waveform diagram for explaining a method for driving address electrodes according to an exemplary embodiment of the present invention;

FIG. 4A is a diagram for explaining a method for driving address electrodes according to an exemplary embodiment of the present invention;

FIG. 4B is a diagram for explaining a method for driving address electrodes according to an exemplary embodiment of the present invention;

FIG. 4C is a diagram for explaining a method for driving address electrodes according to an exemplary embodiment of the present invention;

FIG. 5A illustrates an apparatus for driving a plasma display panel according to an exemplary embodiment of the present invention;

FIG. 5B is a circuit diagram of an apparatus for driving address electrodes according to an exemplary embodiment of the present invention;

FIG. 6A illustrates a driving voltage rising in two stages; and

FIG. 6B illustrates a driving voltage falling in two stages.

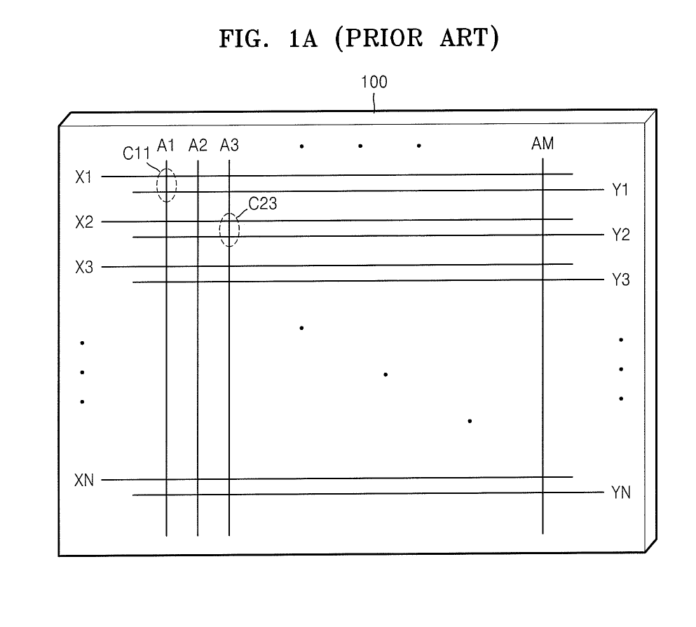

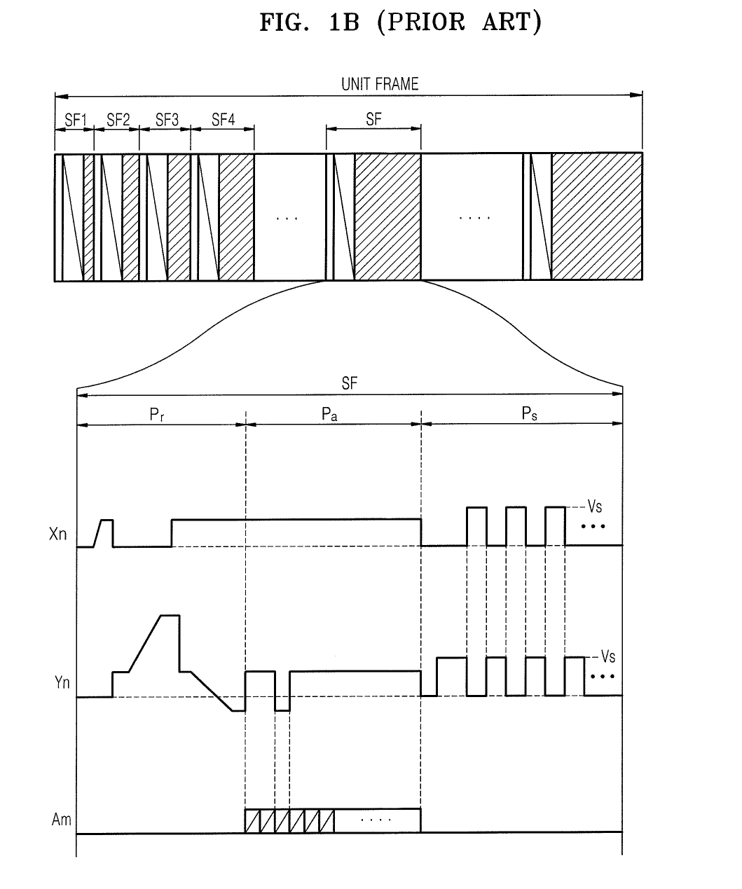

### DETAILED DESCRIPTION OF EXEMPLARY EMBODIMENTS

Exemplary embodiments of the present invention will now be described more fully with reference to the accompanying drawings, in which the exemplary embodiments of the invention are shown. The invention may, however, be embodied in many different forms and should not be construed as being limited to the exemplary embodiments set forth herein; rather, these exemplary embodiments are provided so that this disclosure will be thorough and complete, and will fully convey the concept of the invention to those of ordinary skill in the art. Throughout the drawings, like reference numerals refer to like elements.

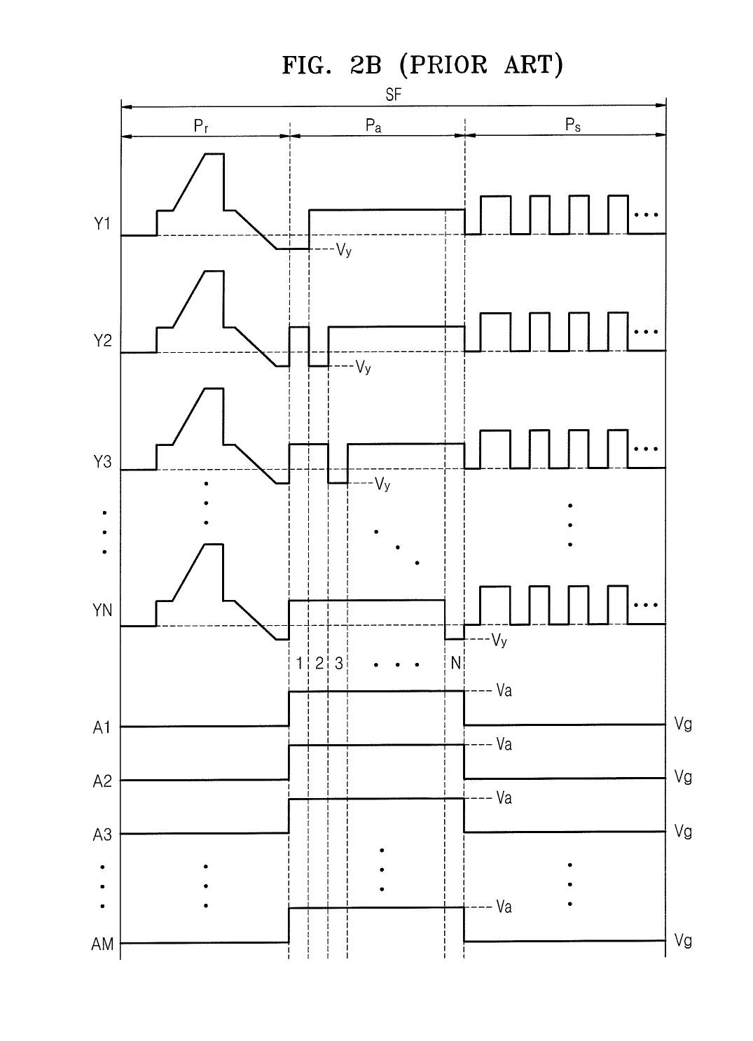

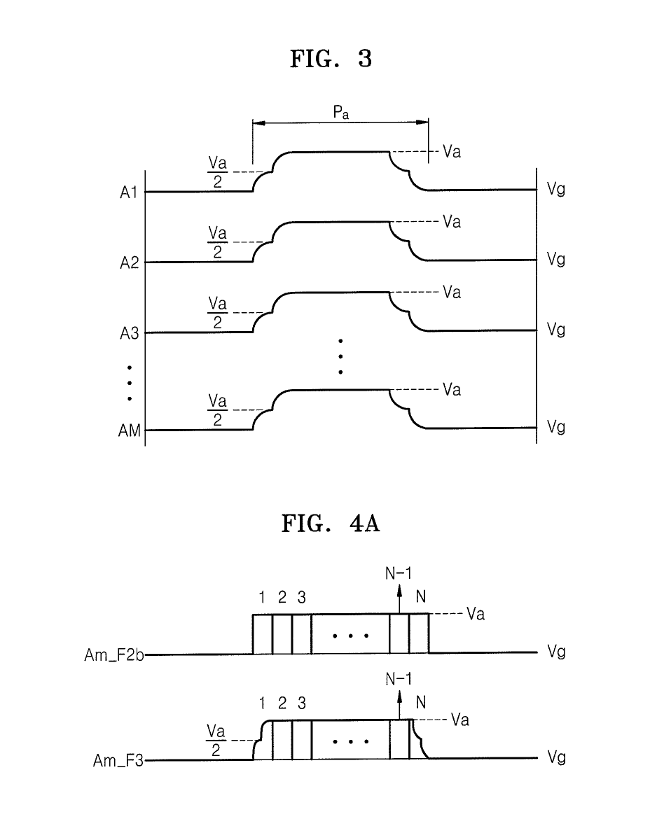

FIG. 3 is a diagram for explaining a method for driving address electrodes according to an exemplary embodiment of the present invention. FIG. 3 illustrates driving voltages respectively applied to M address electrodes A1 through AM when discharge cells of N rows and M columns are all selected in an address period Pa.

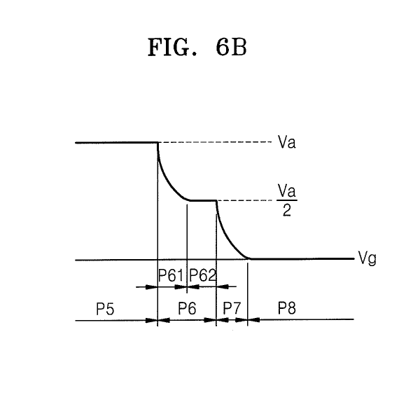

When driving voltages respectively applied to M discharge cells belonging to the first row rise from a reference voltage Vg to an address voltage Va, a driving voltage rising in two stages as illustrated in FIG. 3, instead of a step-type rising driving voltage as illustrated in FIG. 28, is applied to the M address electrodes A1 through AM. The driving voltage rising in two stages rises from the reference voltage Vg to an intermediate voltage Va/2 and then rises from the intermediate voltage Va/2 to the address voltage Va. The waveform of the driving voltage rising in two stages will be explained in more detail with reference to FIG. 6A.

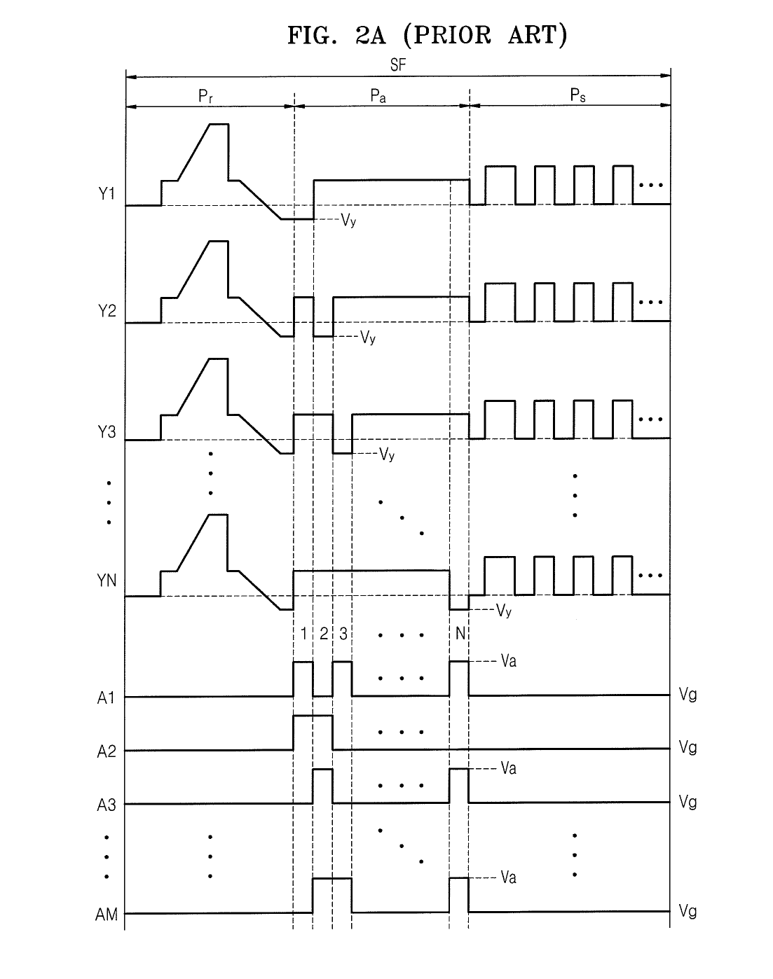

When driving voltages respectively applied to M discharge cells belonging to the Nth row fall from the address voltage Va to the reference voltage Vg, a driving voltage falling in two stages as illustrated in FIG. 3, instead of a step-type felling driving voltage as illustrated in FIG. 2B, is applied to the M address electrodes A1 through AM. The driving voltage falling in two stages falls from the address voltage Va to the intermediate voltage Va/2 first and then falls from the intermediate voltage Va/2 to the reference voltage Vg. The waveform of the driving voltage falling in two stages will be explained in more detail with reference to FIG. 6B.

When a driving voltage rising in two stages and falling in two stages is applied to address electrodes, an abrupt current variation or voltage variation in the address period is decreased and, thus, electromagnetic interference generated in the address period Pa can be reduced.

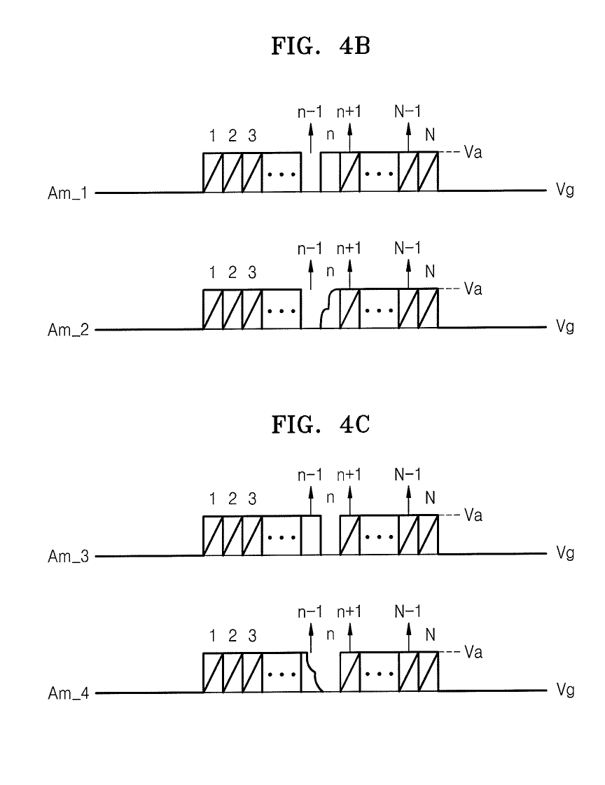

FIG. 4A is a diagram useful for explaining a method for driving address electrodes according to an exemplary embodiment of the present invention. The upper part of FIG. 4A corresponds to FIG. 2B and the lower part of FIG. 4A corresponds to FIG. 3. That is, an address electrode Am_F2b illustrated in FIG. 4A represents the address electrodes A1 through AM illustrated in FIG. 2B and an address electrode Am_F3 represents the address electrodes A1 through AM illustrated in FIG. 3.

FIG. 4A illustrates a case where discharge cells of N rows and M columns are all selected in the address period Pa. In a period 1 (corresponding to the first row) of the address period Pa, a driving voltage rising from the reference voltage Vg to the intermediate voltage Va/2 and then rising from the intermediate voltage Va/2 to the address voltage Va is applied to the address electrode Am_F3 while a driving voltage rising from the reference voltage Vg to the address voltage Va is applied to the address electrode Am_F2b. In a period N (corresponding to the Nth row) of the address period Pa, a driving voltage falling from the address voltage Va to the intermediate voltage Va/2 and then falling from the intermediate voltage Va/2 to the reference voltage Vg is applied to the address electrode Am_F3, while a driving voltage falling from the address voltage Va to the reference voltage Vg is applied to the address electrode Am_F2b.

FIG. 4B is a diagram for explaining a method for driving address electrodes according to an exemplary embodiment of the present invention. The upper part of FIG. 4B illustrates a driving voltage applied to an address electrode Am_1 according to a known system and the lower part of FIG. 4B illustrates a driving voltage applied to an address electrode Am_2 according to an exemplary embodiment of the present invention.

FIG. 4B illustrates a case where M discharge cells belonging to the (n−1)th row (n is a natural number selected from 2 through N) are all de-selected and M discharge cells belonging to the nth row are all selected in the address period Pa. In FIG. 4B, a period n−1 of the address period Pa corresponds to the (n−1)th row and a period n of the address period Pa corresponds to the nth row. Discharge cells belonging to rows other than the (n−1)th row and the nth row are selected or de-selected in the address period Pa.

In the periods n−1 and n of the address period Pa, a driving voltage rising in two stages from the reference voltage Vg to the address voltage Va is applied to the address electrode Am_2 while a step-type driving voltage rising from the reference voltage Vg to the address voltage Va is applied to the address electrode Am_1. The driving voltage rising in two stages applied to the address electrode Am_2 rises from the reference voltage Vg to the intermediate voltage Va/2 and then rises from the intermediate voltage Va/2 to the address voltage Va. The waveform of the driving voltage rising in two stages will be explained in more detail with reference to FIG. 6A.

FIG. 4C is a diagram for explaining a method for driving address electrodes according to an exemplary embodiment of the present invention. The upper part of FIG. 4C illustrates a driving voltage applied to an address electrode Am_3 according to a known system, and the lower part of FIG. 4C illustrates a driving voltage applied to an address electrode Am_4 according to an exemplary embodiment of the present invention.

FIG. 4C illustrates a case where the M discharge cells belonging to the (n−1)th row are de-selected and the M discharge cells belonging to the nth row are all de-selected in the address period Pa. Discharge cells belonging to rows other than the (n−1)th row and the nth row are selected or de-selected in the address period Pa.

In the periods n−1 and n of the address period Pa, a driving voltage felling in two stages from the reference voltage Vg to the address voltage Va is applied to the address electrode Am_4, while a step-type driving voltage falling from the reference voltage Vg to the address voltage Va is applied to the address electrode Am_2. The driving voltage falling in two stages applied to the address electrode Am_4 falls from the address voltage Va to the intermediate voltage Va/2 and then falls from the intermediate voltage Va/2 to the reference voltage Vg. The waveform of the driving voltage falling in two stages will be explained in more detail with reference to FIG. 6B.

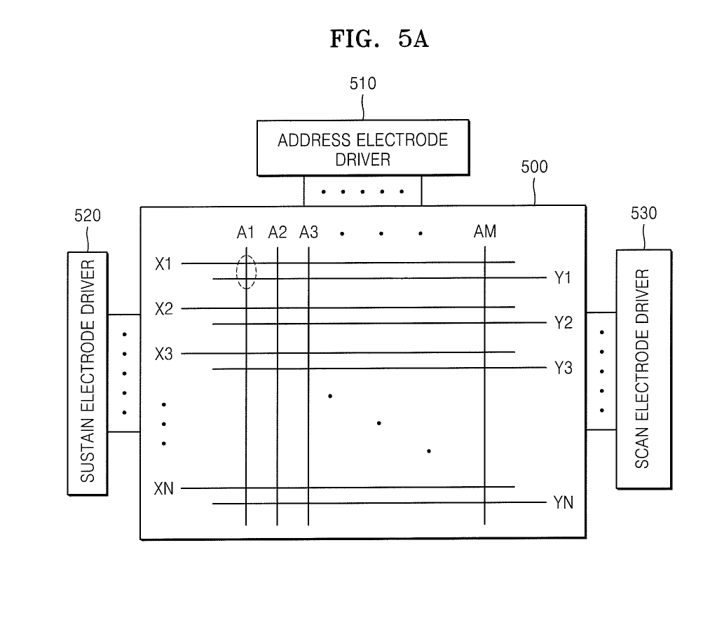

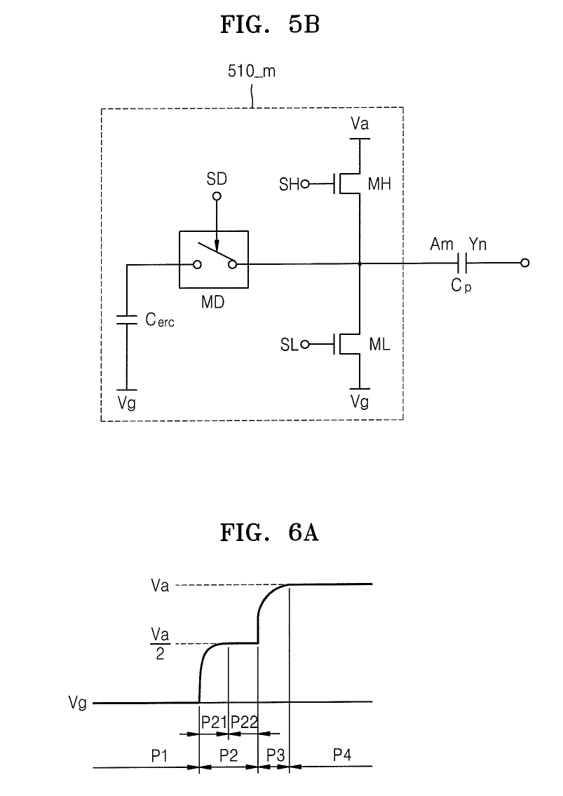

FIG. 5A illustrates an apparatus for driving a plasma display panel 500 according to an exemplary embodiment of the present invention. More specifically, FIG. 5A illustrates a plasma display panel 500, an address electrode driver 510 for driving address electrodes A1 through Am, a sustain electrode driver 520 for driving sustain electrodes X1 through XN, and a scan electrode driver 530 for driving scan electrodes Y1 through YN.

FIG. 5B is a circuit diagram of an apparatus 510_{—}m for driving address electrodes according to an exemplary embodiment of the present invention. The apparatus 510_{—}m for driving address electrodes may be included in the address electrode driver 510 shown in the apparatus of FIG. 5A. The address electrode driving apparatus 510_{—}m includes a high-level transistor MH, a low-level transistor ML, an energy recovery capacitor Cerc and a bidirectional transistor MD. FIG. 5B also illustrates a panel capacitor Cp that is part of an equivalent circuit of a discharge cell.

The high-level transistor MH transfers the address voltage Va to the address electrode Am in response to a control signal SH. The low-level transistor ML transfers the reference voltage Vg to the address electrode Am in response to a control signal SL.

The energy recovery capacitor Cerc exchanges charges with the panel capacitor Cp. Charges accumulated in the panel capacitor Cp are transferred to the energy recovery capacitor Cerc and stored therein after an address discharge occurs between the address electrode Am and the scan electrode Yn and are then used for the next address discharge. Accordingly, energy consumption can be reduced.

The bidirectional transistor MD connects or disconnects the panel capacitor Cp to or from the energy recovery capacitor Cerc in response to a control signal SD. The bidirectional transistor MD is a bidirectional element while the high-level transistor MH and the low-level transistor MD are uni-directional elements. A DMOSFET (double diffused MOSFET) can be used as the bidirectional transistor MD.

The operation of the address electrode driving apparatus 510_{—}m to apply the driving voltage rising in two stages and falling in two stages to the address electrode Am will be explained with reference to FIGS. 6A and 6B.

FIG. 6A illustrates the driving voltage rising in two stages. The driving voltage rising in two stages can be applied to the address electrode Am when driving voltages respectively applied to M discharge cells belonging to an arbitrary row rise from the reference voltage Vg to the address voltage Va, that is, when the discharge cells belonging to the first row are all selected in the period 1 of the address period Pa, as illustrated in FIG. 4A, and when M discharge cells belonging to the (n−1)th row are all de-selected and M discharge cells belonging to the nth row are all selected in the periods n−1 and n of the address period Pa, as illustrated in FIG. 4B.

The driving voltage illustrated in FIG. 6A rises from the reference voltage Vg to the intermediate voltage Va/2, is maintained at the intermediate voltage Va/2 for a predetermined time, rises from the intermediate voltage Va/2 to the address voltage Va, and then is maintained at the address voltage Va.

The period (n−1 illustrated in FIG. 4B) corresponding to the (n−1)th row and the period (n illustrated in FIG. 4B) corresponding to the nth row in the address period Pa can be divided into a reference voltage maintaining period P1, a first rising period P2, a second rising period P3, and an address voltage maintaining period P4. In the reference voltage maintaining period P1, the low-level transistor ML (ML illustrated in FIG. 5B) is turned on and transfers the reference voltage Vg to the address electrode Am.

In the first rising period P2, the low-level transistor (ML illustrated in FIG. 5B) and the high-level transistor (MH illustrated in FIG. 5B) are turned off and the bidirectional transistor (MD illustrated in FIG. 5B) is turned on and, thus, charges accumulated in the energy collecting transistor (Cerc illustrated in FIG. 5B) are transferred to the panel capacitor (Cp illustrated in FIG. 5B). In the first rising period P2, the driving voltage rising from the reference voltage Vg to the intermediate voltage Va/2 is applied to the address electrode Am. The first rising period P2 includes a period P22 during which the driving voltage is maintained at the intermediate voltage Va/2 for the predetermined time. That is, the first rising period P2 can be divided into a rising period P21 and the maintaining period P22. The predetermined time is determined in consideration of the total transition time of the driving voltage rising in two stages.

In the second rising period P3, the high-level transistor (MH illustrated in FIG. 5B) is turned on and, thus, the driving voltage rising from the intermediate voltage Va/2 to the address voltage Va is applied to the address electrode Am. In the address voltage maintaining period P4, the driving voltage maintained at the address voltage Va is applied to the address electrode Am.

In the first rising period P2 and the second rising period P3, the energy recovery capacitor (Cerc illustrated in FIG. 5B) restrains the driving voltage from rising in a step fashion. The capacitance of the energy recovery capacitor (Cerc illustrated in FIG. 5B) is determined in consideration of the total transition time of the driving voltage rising in two stages. As described above, the total transition time of the driving voltage rising in two stages affects the predetermined time of the maintaining period P22. Accordingly, it is possible to prevent electromagnetic interference from becoming concentrated during a specific time period when the total transition time of the driving voltage rising in two stages is appropriately controlled.

FIG. 6B illustrates a driving voltage falling in two stages. The driving voltage falling in two stages can be applied to the address electrode Am when driving voltages respectively applied to M discharge cells belonging to an arbitrary row fall from the address voltage Va to the reference voltage Vg, that is, when the discharge cells belonging to the Nth row are all selected in the period N of the address period Pa, as illustrated in FIG. 4A, and when M discharge cells belonging to the (n−1)th row are all selected and M discharge cells belonging to the nth row are all de-selected in the periods n−1 and n of the address period Pa, as illustrated in FIG. 4C.

The driving voltage illustrated in FIG. 6B falls from the address voltage Va to the intermediate voltage Va/2, is maintained at the intermediate voltage Va/2 for a predetermined time, falls from the intermediate voltage Va/2 to the reference voltage Vg, and then is maintained at the reference voltage Va.

The period (n−1 illustrated in FIG. 4C) corresponding to the (n−1)th row and the period (n illustrated in FIG. 4C) corresponding to the nth row in the address period Pa can be divided into an address voltage maintaining period P5, a first falling period P6, a second falling period P7, and a reference voltage maintaining period P8. In the address voltage maintaining period P5, the high level transistor (MH illustrated in FIG. 5B) is turned on and transfers the address voltage Va to the address electrode Am.

In the first falling period P6, the low-level transistor (ML illustrated in FIG. 5B) and the high-level transistor (MH illustrated in FIG. 5B) are turned off and the bidirectional transistor (MD illustrated in FIG. 5B) is turned on and, thus, charges accumulated in the panel capacitor (Cp illustrated in FIG. 5B) are transferred to the energy recovery capacitor (Cerc illustrated in FIG. 5B). In the first falling period P6, the driving voltage falling from the address voltage Va to the intermediate voltage Va/2 is applied to the address electrode Am. The first falling period P6 includes a period P62 during which the driving voltage is maintained at the intermediate voltage Va/2 for a predetermined time. That is, the first failing period P6 can be divided into a felling period P61 and the maintaining period P62. The predetermined time is determined in consideration of the total transition time of the driving voltage falling in two stages.

In the second falling period P7, the low-level transistor (ML illustrated in FIG. 5B) is turned on and, thus, the driving voltage felling from the intermediate voltage Va/2 to the reference voltage Vg is applied to the address electrode Am. In the reference voltage maintaining period P8, the driving voltage maintained at the reference voltage Vg is applied to the address electrode Am.

In the first falling period P6 and the second falling period P7, the energy recovery capacitor (Cerc illustrated in FIG. 5B) restrains the driving voltage from falling in a step fashion. The capacitance of the energy recovery capacitor (Cerc illustrated in FIG. 5B) is determined in consideration of the total transition time of the driving voltage failing in two stages. As described above, the total transition time of the driving voltage falling in two stages affects the predetermined time of the maintaining period P62. Accordingly, it is possible to prevent electromagnetic interference from becoming concentrated during a specific time when the total transition time of the driving voltage falling in two stages is appropriately controlled.

The voltage level of the intermediate voltage is determined by the capacitance of the energy recovery capacitor Cerc. While the voltage level of the intermediate voltage is described to be half of the voltage level of the address voltage Va in FIGS. 3, 4A, 4B, 4C, 6A and 6B, the voltage level of the intermediate voltage is not limited to Va/2.

According to exemplary embodiments of the present invention, an abrupt current variation or voltage variation in the address period can be decreased and, thus, electromagnetic interference generated in the address period can be reduced. Furthermore, it is possible to prevent electromagnetic interference from becoming concentrated during a specific period when the total transition time of the driving voltage rising in two stages and the total transition time of the driving voltage falling in two stages are appropriately controlled.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for driving M address electrodes included in a plasma display panel in an address period for selecting specific discharge cells from discharge cells of N rows and M columns, comprising:
applying a driving voltage rising in two stages from a reference voltage to an address voltage to the M address electrodes in periods of the address period that correspond to an (n−1)th row and an nth row, where n is a natural number selected from 2 through N, when M discharge cells belonging to the (n−1)th row are ail de-selected and M discharge cells belonging to the nth row axe all selected,
wherein the driving voltage rising in two stages is generated using an energy recovery capacitor, rises from the reference voltage to an intermediate voltage, and then rises from the intermediate voltage to the address voltage.

2. The method of claim 1, wherein a period during which the driving voltage rises from the reference voltage to the intermediate voltage includes a period during which the driving voltage is maintained at the intermediate voltage for a predetermined time.

3. The method of claim 2, wherein the predetermined time is determined in consideration of the total transition time of the driving voltage rising in two stages.

4. The method of claim 1, wherein the energy recovery capacitor restrains the driving voltage rising in two stages from rising in step fashion.

5. The method of claim 4, wherein the capacitance of the energy recovery capacitor is determined in consideration of the total transition time of the driving voltage rising in two stages.

6. The method of claim 1, wherein the capacitance of the energy recovery capacitor is determined in consideration of the voltage level of the intermediate voltage.

7. The method of claim 6, wherein the voltage level of the intermediate voltage is an average of the voltage level of the reference voltage and the voltage level of the address voltage.

8. A method for driving M address electrodes included in a plasma display panel in an address period for selecting specific discharge cells from discharge cells of N rows and M columns, comprising:
applying a driving voltage falling in two stages from an address voltage to a reference voltage to the M address electrodes in periods of the address period that correspond to an (n−1)th row and an nth row, where n is a natural number selected from 2 through N, when M discharge cells belonging to the (n−1)th row are all selected and M discharge cells belonging to the nth row are all de-selected,
wherein the driving voltage falling in two stages is generated using an energy recovery capacitor, falls from the address voltage to an intermediate voltage, and then falls from the intermediate voltage to the reference voltage.

9. The method of claim 8, wherein a period during which the driving voltage falls from the address voltage to the intermediate voltage includes a period during which the driving voltage is maintained at the intermediate voltage for a predetermined time.

10. The method of claim 9, wherein the predetermined time is determined in consideration of the total transition time of the driving voltage falling in two stages.

11. The method of claim 8, wherein the energy recovery capacitor restrains the driving voltage falling in two stages from falling in step fashion.

12. The method of claim 11, wherein the capacitance of the energy recovery capacitor is determined in consideration of the voltage level of the total transition time of the driving voltage felling in two stages.

13. The method of claim 8, wherein the capacitance of the energy recovery capacitor is determined in consideration of the voltage level of the intermediate voltage.

14. The method of claim 13, wherein the voltage level of the intermediate voltage is an average of the voltage level of the address voltage and the voltage level of the reference voltage.

15. A method for driving M address electrodes included in a plasma display panel in an address period for selecting specific discharge cells from discharge cells of N rows and M columns, comprising:
when all discharge cells are selected in the address period,
applying a driving voltage rising in two stages from a reference voltage to an address voltage to the M address electrodes in a period of the address period which corresponds to a first row; and
applying a driving voltage falling in two stages from the address voltage to the reference voltage to the M, address electrodes in a period of the address period which corresponds to the Nth row,
wherein the driving voltage rising in two stages is generated using an energy recovery capacitor, rises from the reference voltage to an intermediate voltage, and then rises from the intermediate voltage to the address voltage, and
the driving voltage falling in two stages is generated using the energy recovery capacitor, falls from the address voltage to the intermediate voltage, and then falls from the intermediate voltage to the reference voltage.

16. The method of claim 15, wherein the driving voltage rising in two stages rises from the reference voltage to the intermediate voltage, is maintained at the intermediate voltage for a predetermined time, rises from the intermediate voltage to the address voltage, and then is maintained at the address voltage.

17. The method of claim 15, wherein the driving voltage falling in two stages falls from the address voltage to the intermediate voltage, is maintained at the intermediate voltage for a predetermined time, falls from the intermediate voltage to the reference voltage, and then is maintained at the reference voltage.

18. An apparatus for driving address electrodes included in a plasma display panel in an address period for selecting specific discharge cells from discharge cells of N rows and M columns, comprising:
a high-level transistor transferring an address voltage to an address electrode;
a low-level transistor transferring a reference voltage to the address electrode;
an energy recovery capacitor exchanging charges with a panel capacitor included in an equivalent circuit of a discharge cell; and
a bidirectional transistor connecting or disconnecting the panel capacitor to or from the energy recovery capacitor,
wherein a driving voltage rising in two stages from the reference voltage to the address voltage is applied to the address electrodes in periods of the address period that correspond to an (n−1)th row and an nth row, where n is a natural number selected from 2 through N, when M discharge cells belonging to the (n−1)th row are all de-selected and M discharge cells belonging to the nth row are all selected.

19. The apparatus of claim 18, wherein the driving voltage rising in two stages rises from the reference voltage to an intermediate voltage and then rises from the intermediate voltage to the address voltage.

20. The apparatus of claim 19, wherein the bidirectional transistor is turned on such that charges accumulated in the energy recovery capacitor are transferred to the panel capacitor to apply the driving voltage rising from the reference voltage to the intermediate voltage to the address electrodes, and the high-level transistor is turned on such that the address voltage is transferred to the panel capacitor to apply the driving voltage rising from the intermediate voltage to the address voltage to the address electrodes.

21. An apparatus for driving address electrodes included in a plasma display panel in an address period for selecting specific discharge cells from discharge cells of N rows and M columns, comprising:
a high-level transistor transferring an address voltage to address electrode;
a low-level transistor transferring a reference voltage to the address electrode;
an energy recovery capacitor exchanging charges with a panel capacitor included in an equivalent circuit of a discharge cell; and
a bidirectional transistor connecting or disconnecting the panel capacitor to or from the energy recovery capacitor,
wherein a driving voltage falling in two stages from, the address voltage to the reference voltage is applied to the address electrodes in periods of the address period that correspond to an (n−1)th row and an nth row, where n is a natural number selected from 2 through N, when M discharge cells belonging to the (n−1)th row are all selected and M discharge cells belonging to the nth row are all de-selected.

22. The apparatus of claim 21, wherein the driving voltage falling in two stages falls from the address voltage to an intermediate voltage and then falls from the intermediate voltage to the reference voltage.

23. The apparatus of claim 22, wherein the bidirectional transistor is turned on such that charges accumulated in the panel capacitor are transferred to the energy recovery capacitor to apply the driving voltage falling from the address voltage to the intermediate voltage to the address electrodes, and the low-level transistor is turned on such that the reference voltage is transferred to the panel capacitor to apply the driving voltage falling from the intermediate voltage to the reference voltage to the address electrodes.
